(19) United States
(12) Patent Application Publication
(10) Pub. No.: US 2026/0326663 A1
(43) Pub. Date: Oct. 22, 2026

(54) ONBOARD LIGHTING DEVICE AND INTELLIGENT LIGHTING CONTROL METHOD THEREOF

(71) Applicant: Easida Optoelectronics (Guangdong) Co., LTD, Zhongshan (CN)

(72) Inventors: Baozhou XU, Zhuhai (CN); Liang ZHAO, Zhongshan (CN); Lindao SHI, Zhongshan (CN)

(21) Appl. No.: 19/215,620

(22) Filed: May 22, 2025

(30) Foreign Application Priority Data
Apr. 17, 2025 (CN) 202510484118.4
Apr. 21, 2025 (CN) 202510499066.8

(51) Int. Cl. B60Q 1/46; B60Q 1/04; G06T 5/20; G06T 5/92; G06T 7/20; G06T 7/571; G06T 7/70; G06V 10/36; G06V 10/82; G06V 20/58; H05B 47/125

(52) U.S. Cl. CPC B60Q 1/46; G06T 5/20; G06T 5/92; G06T 7/20; G06T 7/571; G06T 7/70; G06V 10/36; G06V 10/82; G06V 20/58; H05B 47/125; B60Q 1/04; B60Q 2300/112; B60Q 2300/114; B60Q 2300/32; B60Q 2300/41; G06T 2207/20081; G06T 2207/20084; G06T 2207/20192; G06T 2207/30252; G06V 2201/07; G06V 2201/08

(57) ABSTRACT

An intelligent lighting control method, including performing a format processing to continuous image data; and generating optimized image data; based on the optimized image data, performing a target detection to get target detection results; analyzing the target detection results to evaluate a distance data, calculating a status analysis result of the preceding vehicle based on the distance data; deciding whether to flash vehicle lights of the host vehicle, and generating a vehicle light control instruction; monitoring an emergency brake signal to generate an emergency response execution result. The present disclosure formats and optimizes the images through contrast adjustment, improves the accuracy of object detection, reduces interference factors caused by changes in environmental lighting; On the basis of optimized images to perform target detection and evaluate the real-time distance status of preceding vehicle, making the perception of road conditions more accurate and improving the intelligence and real-time control of vehicle lighting.

### CROSS REFERENCE TO RELATED APPLICATIONS

This application claims foreign priority of Chinese Patent Applications No. 202510499066.8 filed on Apr. 21, 2025 and 201510484118.4 filed on Apr. 17, 2025 in the China National Intellectual Property Administration, the disclosures of all of which are hereby incorporated by reference.

### TECHNICAL FIELD

The present disclosure relates to the technical field of image processing technology, in particular to an onboard lighting device and an intelligent lighting control method thereof.

### BACKGROUND

The field of image processing technology refers to techniques that utilize computers to analyze, enhance, reconstruct, and understand images. This includes steps such as image acquisition, preprocessing, feature extraction, recognition and classification, image enhancement, and object detection and tracking. By analyzing and processing image data, this technology enables precise perception, recognition, and decision-making regarding the environment or objects. It is widely used in fields such as autonomous driving, security monitoring, medical diagnosis, facial recognition, and industrial inspection, improving the intelligence, automation, and precision of systems.

In existing technologies, when a vehicle is traveling at high speeds and the vehicle ahead suddenly brakes or road conditions deteriorate rapidly, current technologies are limited by delayed information analysis, causing slow or untimely response in the vehicle lights' flashing or light adjustment. This results in the driver not receiving accurate and effective visual warning signals at critical moments, increasing the risk of collisions or accidents. Therefore, there is a need for improvements in lighting control.

### SUMMARY

The present disclosure provides an onboard lighting device and an intelligent lighting control method thereof, to solve disadvantages existing in the prior art.

To realize the above objective, the present disclosure provides an intelligent lighting control method, including the following steps:
S1, performing a format processing to continuous image data captured by a vehicle camera of a host vehicle to generate formatted image data; and optimizing the formatted image data by adjusting contrast to generate optimized image data; and
S2, based on the optimized image data, performing a target detection to identify other vehicles and road signs, and getting target detection results; analyzing the target detection results to evaluate a distance data between the host vehicle and a preceding vehicle, calculating a status analysis result of the preceding vehicle based on the distance data; and
S3, based on the status analysis result of the preceding vehicle, deciding whether to flash vehicle lights of the host vehicle, and generating a vehicle light control instruction; and
S4 monitoring an emergency brake signal of the preceding vehicle and sudden road conditions, and updating a flashing frequency of the vehicle lights based on the emergency brake signal of the preceding vehicle and the sudden road conditions, taking the flashing frequency as an emergency response execution result.

The present disclosure further provides an onboard lighting device, being applied for the intelligent lighting control method, including: a lamp housing with heat dissipation holes on an outer wall; a light source substrate and a printed circuit board (PCB) are located inside the lamp housing, the PCB is electrically connected to the light source substrate; both sides of the light source substrate is equipped with light emitting diode (LED) chips; the lamp housing includes a first cooling fan for cooling the light source substrate and a second cooling fan for cooling the PCB; and an end of the lamp housing is equipped with a plug electrically connected to a rectifier of the PCB; the light source substrate is equipped with a connection terminal electrically connected to the first cooling fan; and the lamp housing further includes a light-transmitting opening corresponding to a light-emitting surface of each of the LED light chips.

Compared with the existing technology, the advantages and positive effects of the present disclosure are as follows:

The present disclosure captures continuous image data through vehicle camera of the host vehicle, formats and optimizes the contrast of the continuous image data to enhance the accuracy of target detection and reduce the interference caused by changes in ambient lighting. Target detection is performed based on the optimized image data, allowing for real-time identification of vehicles and road signs on the road, and evaluation of the real-time distance status of vehicles ahead. This enables more accurate perception of road conditions ahead and improves the intelligence and real-time control of vehicle lighting. A vehicle light control instruction is generated promptly based on the status analysis result of the preceding vehicle, effectively alerting the driver to potential risks in advance, reducing driver reaction delays. At the same time, emergency braking signal from the preceding vehicle and sudden road conditions are continuously monitored, and the flashing frequency is dynamically adjusted, responding to sudden conditions more quickly and accurately, thus enhancing driving safety and vehicle stability. The deep intelligence of lighting control strategy is realized, effectively improving driving visibility and safety in complex road conditions or at night.

### BRIEF DESCRIPTION OF THE DRAWINGS

FIG. 1 is a schematic diagram of a composition of an intelligent lighting control device according to an embodiment of the present disclosure.

FIG. 2 is a flowchart of the intelligent lighting control method according to an embodiment of the present disclosure.

FIG. 3 is a schematic diagram of the hardware structure of the intelligent lighting control equipment involved in the various embodiments of the present disclosure.

FIG. 4 is a first detailed flowchart of the intelligent lighting control method according to an embodiment of the present disclosure.

FIG. 5 is a second detailed flowchart of the intelligent lighting control method according to an embodiment of the present disclosure.

FIG. 6 is a third detailed flowchart of the intelligent lighting control method according to an embodiment of the present disclosure.

FIG. 7 is a fourth detailed flowchart of the intelligent lighting control method according to an embodiment of the present disclosure.

FIG. 8 is a fifth detailed flowchart of the intelligent lighting control method according to an embodiment of the present disclosure.

FIG. 9 is a sixth detailed flowchart of the intelligent lighting control method according to an embodiment of the present disclosure.

FIG. 10 is an exploded diagram of an onboard lighting device according to a first embodiment of the present disclosure.

FIG. 11 is a schematic structural diagram of the onboard lighting device in FIG. 10.

FIG. 12 is an exploded diagram of the onboard lighting device according to a second embodiment of the present disclosure.

FIG. 13 is a schematic structural diagram of the onboard lighting device in FIG. 12.

FIG. 14 is an exploded diagram of the onboard lighting device according to a third embodiment of the present disclosure.

FIG. 15 is an internal schematic structural diagram of the onboard lighting device in FIG. 14.

FIG. 16 is a schematic structural diagram of the onboard lighting device in FIG. 14.

### DESCRIPTION OF THE REFERENCE NUMERAL

1 lamp housing, 2 light source substrate, 3 PCB, 4 plug, 5 pin header, 10 heat dissipation hole, 11 first cooling fan, 12 second cooling fan, 13 transparent port, 21 LED light chip, 22 connection terminal, 23 heat-conducting tube, 31 mounting hole, 32 control circuit board, 33 rectifier circuit board.

### DETAILED DESCRIPTION OF THE EMBODIMENTS

The technical solutions in the embodiments of the present disclosure will be described clearly and completely with reference to the accompanying drawings in the embodiments of the present disclosure. Obviously, the described embodiments are only a part of the embodiments of the present disclosure rather than all of them. Based on the embodiments in the present disclosure, all other embodiments obtained by those skilled in the art without creative work shall fall within the scope of protection of the present disclosure.

In order to further clarify the purpose, technical solution, and advantages of the present disclosure, the following will provide a detailed explanation of the present disclosure in conjunction with the accompanying drawings and embodiments. It should be understood that the specific embodiments described herein are only used to explain the present disclosure and are not intended to limit the present disclosure.

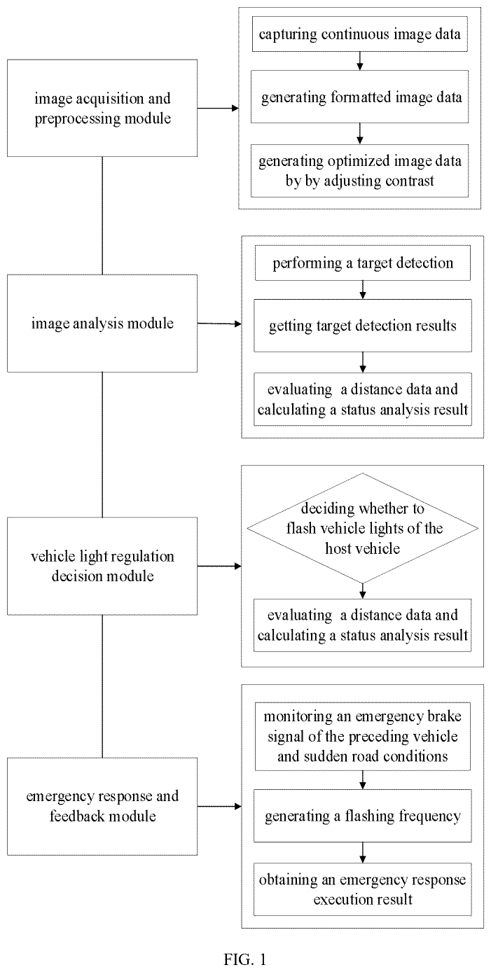

Referring to FIG. 1, the present disclosure provides an intelligent lighting control device, includes an image acquisition and preprocessing module, an image analysis module, a vehicle light regulation decision module, and an emergency response and feedback module. Each module is configured to execute the steps of the intelligent lighting control method.

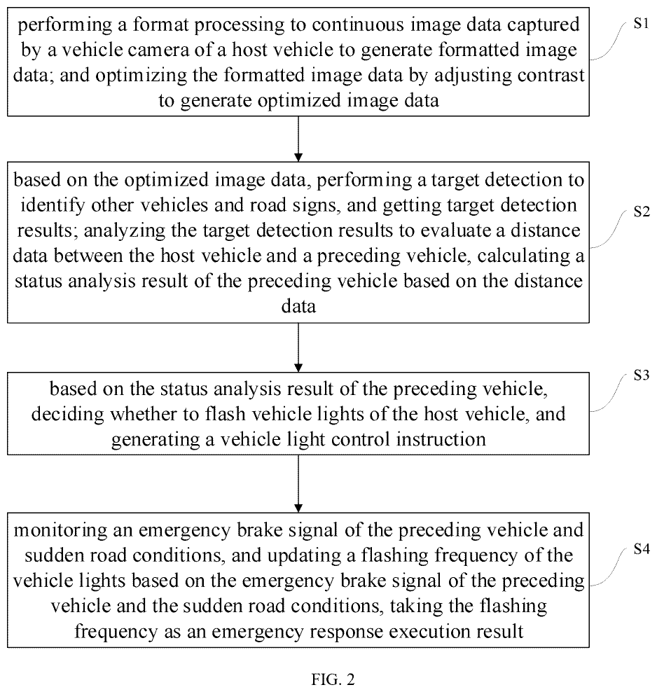

Referring to FIG. 2, the present disclosure provides an intelligent lighting control method.

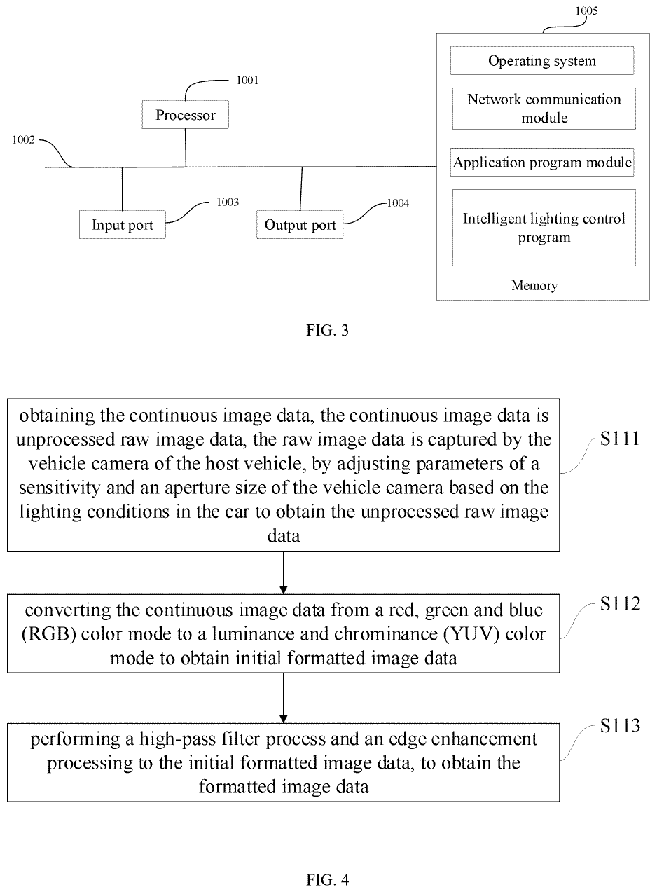

The intelligent lighting control method is processed by an intelligent lighting control equipment. As shown in FIG. 3, the intelligent lighting control equipment includes: a processor 1001 (such as Central Processing Unit, CPU), a communication bus 1002, an input port 1003, an output port 1004, and a memory 1005. Among them, the communication bus 1002 is used to achieve connection communication between these components; the input port 1003 is used for data input; and the output port 1004 is used for data output, and the memory 1005 can be high-speed RAM memory or non volatile memory, such as disk memory, non-transitory computer-readable storage medium. Optionally, memory 1005 is a storage device independent of the aforementioned processor 1001.

The memory 1005, as a non-volatile readable storage medium, may include an operating system, network communication module, application program module, and a intelligent lighting control program. The network communication module is mainly used to connect to servers and communicate data with them. And the processor 1001 is used to call the program to process the method stored in memory 1005, and execute all steps of the intelligent lighting control method mentioned above.

As shown in FIG. 2, the intelligent lighting control method includes the following steps.
S1, performing a format processing to continuous image data captured by a vehicle camera of a host vehicle to generate formatted image data; and optimizing the formatted image data by adjusting contrast to generate optimized image data.
S2, based on the optimized image data, performing a target detection to identify other vehicles and road signs, and getting target detection results; analyzing the target detection results to evaluate a distance data between the host vehicle and a preceding vehicle, calculating a status analysis result of the preceding vehicle based on the distance data.
S3, based on the status analysis result of the preceding vehicle, deciding whether to flash vehicle lights of the host vehicle, and generating a vehicle light control instruction.
S4, monitoring an emergency brake signal of the preceding vehicle and sudden road conditions, and updating a flashing frequency of the vehicle lights based on the emergency brake signal of the preceding vehicle and the sudden road conditions, taking the flashing frequency as an emergency response execution result.

As shown in FIG. 4, S1 of performing a format processing to continuous image data captured by a vehicle camera of the host vehicle to generate formatted image data includes the following steps.

S111, obtaining the continuous image data, the continuous image data is unprocessed raw image data, the raw image data is captured by the vehicle camera of the host vehicle, by adjusting parameters of a sensitivity and an aperture size of the vehicle camera based on the lighting conditions in the car to obtain the unprocessed raw image data.

S112, converting the continuous image data from a red, green and blue (RGB) color mode to a luminance and chrominance (YUV) color mode to obtain initial formatted image data.

S113, performing a high-pass filter process and an edge enhancement processing to the initial formatted image data, to obtain the formatted image data.

Specifically, at the shooting site, the vehicle camera is placed, and the light intensity is obtained through an ambient light illuminance sensor and compared with a range of 0 lx to 30,000 lx. If the measured illuminance is lower than 500 lx, a higher ISO value is selected within the range of ISO 100 to ISO 800, and an aperture is set to f/2.8 to f/4. If the illuminance is between 500 lx and 2000 lx, ISO is selected within the range of ISO 100 to ISO 400, and the aperture is set to f/5.6 to f/8. These values, such as 500 lx and 2000 lx, are based on image data collected from multiple shooting environments and combined with empirical statistics. Alternatively, depending on the actual conditions at the site, 500 lx can be replaced with 300 lx or 700 lx, and 2000 lx can be replaced with 1500 lx or 2500 lx. After each illuminance measurement, the process of adjusting ISO and aperture is repeated, and the same operation is applied to each frame of continuous shooting. When the illuminance exceeds 2000 lx, ISO can be controlled between 100 and 200, and the aperture is set to f/8 to f/16. In darker environments, ISO can be appropriately raised to 800 or above, and the aperture value can be lowered to below f/2.8. The light measurement values and camera parameters are recorded sequentially over time, ultimately resulting in the unprocessed raw image data.

When reading the obtained unprocessed raw image data, the red, green, and blue (RGB) channel values of each pixel are extracted and recorded in a temporary array. A conversion matrix is then constructed based on the ITU-R BT. 709 recommendation or other common standards. For example, the following formulas can be used.

Y=0.2126R+0.7152G+0.0722B; and

U=−0.1146R−0.3854G+0.5000B; and

V=0.5000R−0.4542G−0.0458B.

In this matrix, the required coefficients are derived from reference publications or through fitting tests with typical image samples and can be slightly adjusted within the range of 0.001 to 1.000 to fit specific image characteristics. Next, linear operations are performed on the RGB components of each pixel in the image, and the results are written into the corresponding luminance and chrominance (YUV) component locations. If the image contains an Alpha channel, the Alpha data remains unchanged. The entire conversion process requires iterating through all the pixels of the image. When there are a large number of pixels, row-by-row processing can be considered, where each row is processed before moving on to the next. After all rows are processed, the converted YUV data is combined into a new image format, resulting in the formatted image data.

When reading the formatted image data obtained in the previous steps, the high-pass filter process is first applied to the luminance component (Y). A 3×3 convolution kernel can be used, such as a matrix with the center position as +8, the positions up, down, left, and right as −1, and the diagonal positions as 0. By calculating pixel by pixel, Y_{filtered}=Σ(K_{i,j}×Y_{neighbors}) is applied to highlight the high-frequency components of the image. The convolution kernel coefficients are determined by adjusting the noise and detail performance in test images. If the contrast of a local area after the high-pass filter process is too strong, an attenuation coefficient is adjusted within the range of 0.1 to 1.0, and the filter result is multiplied by this attenuation coefficient before being added to the original Y component to form a preliminary edge enhancement effect. Then, differential calculations can be applied to the U and V components in the same way, or edge enhancement processing can be performed only on the Y component. If the intensity of certain edges needs to be limited, additional judgment conditions can be added. For example, the edge enhancement processing is only performed when the filter result exceeds a pre-set threshold. The pre-set threshold can be determined by estimating the contrast of the noise region in sample images, typically set between 10 and 50, and can be adjusted in steps of 5. After processing all pixels, the new YUV data is summarized and recorded as the new image output state, ultimately obtaining the formatted image data.

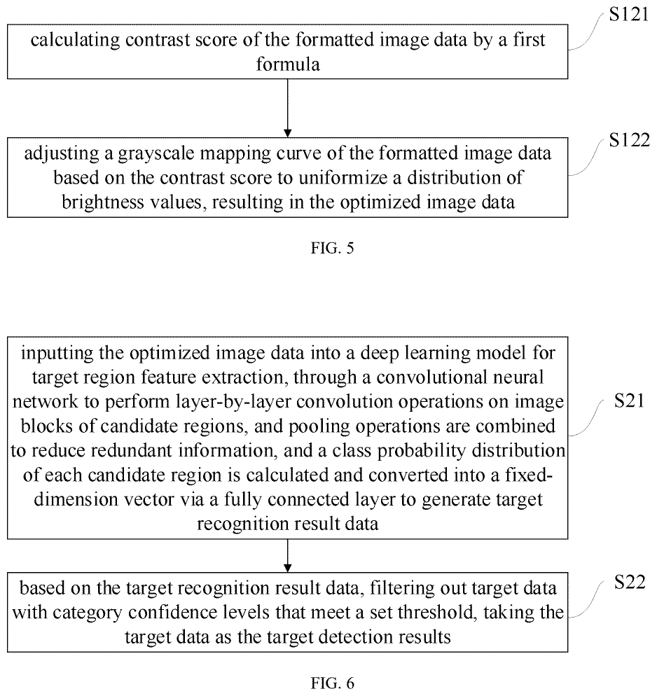

As shown in FIG. 5, S1 of optimizing the formatted image data by adjusting contrast to generate optimized image data is as follows.

S121, calculating contrast score of the formatted image data by a first formula, the first formula is as following:

$$C = \sqrt{\begin{matrix}\frac{1}{m \times n} {\sum }_{i = 1}^{m} {\sum }_{j = 1}^{n} ( \frac{\vert {P}_{i , j} - {P}_{min} \vert}{{P}_{max} - {P}_{min}} + \frac{\vert {P}_{i , j} - \overline{P} \vert}{\overline{P}} + \\ \frac{\vert {P}_{i , j} - {P}_{i - 1 , j} \vert + \vert {P}_{i , j} - {P}_{i , j - 1} \vert}{2} )\end{matrix}} ;$$

C is the contrast score, P_{i,j} is a brightness value of a pixel at row i, column j; Pₘₐₓ and Pₘᵢₙ are maximum and minimum brightness values of the formatted image data; P̅ is an average brightness of the formatted image data; m and n are numbers of rows and columns; and P_{i-1,j} and P_{i,j-1} represent brightness values of a top pixel and a left pixel adjacent to a current pixel.

S122, adjusting a grayscale mapping curve of the formatted image data based on the contrast score to uniformize a distribution of brightness values, resulting in the optimized image data.

The advantage of the first formula is that by measuring the differences between the pixel values and the extreme values of the image's brightness range, the differences between the pixel values and the overall average brightness, and the differences between adjacent pixels, multiple metrics are incorporated into a single score. This allows for a comprehensive representation of the image's brightness distribution, local contrast, and neighborhood variations, thereby more accurately reflecting the overall contrast. The following details the steps for obtaining each parameter.

Obtaining P_{i,j}. The parameter P_{i,j} represents the brightness value of the pixel at the i-th row and j-th column in the processed image the formatted image data. To obtain the brightness value, the RGB components of each pixel in the image need to be converted into a grayscale value, either by using the luminance component or another method. If the traditional grayscale formula is used, the values from the three channels can be combined to obtain an integer brightness value in the range of 0 to 255 through the traditional grayscale formula of Y=0.299R+0.587G+0.114B. When reading a 1920×1080 image, the rows and columns are scanned sequentially, and the corresponding pixel values of R, G, and B are obtained, which are then calculated using the traditional grayscale formula above. For example, if the R=100, G=150, and B=200 for a given pixel, the corresponding brightness value can be calculated. After obtaining the brightness values for all pixels, they can be directly used in subsequent contrast scoring calculations.

Obtaining the parameter Pₘₐₓ. This parameter represents the maximum brightness value in the processed image the formatted image data. The method for obtaining the Pₘₐₓ is to traverse all the pixel brightness data, store them in an array, and then find the highest brightness value in the array. For example, in the set of all brightness values obtained, if the maximum brightness value is 247, then this is the maximum brightness. In practice, the entire 1920×1080 image is scanned, with each pixel's brightness is compared and the maximum brightness recorded and updated in real time. After scanning the entire image, the maximum brightness value Pₘₐₓ is obtained.

Obtaining parameter Pₘᵢₙ. This parameter represents the minimum brightness value in the processed image of the formatted image data. Similar to the maximum brightness value Pₘₐₓ, the minimum brightness value Pₘₐₓ is obtained by traversing the pixel brightness values and recording the minimum value through comparison. If the brightness value 12 is encountered and it is the smallest during the full scan, then it is recorded as Pₘᵢₙ=12. If a lower value, such as 0, is found, the minimum value Pₘᵢₙ will be updated to 0. Throughout the traversal process, it is necessary to ensure that all pixels are visited. Based on the actual measured results, assume the minimum value obtained is as specified.

Obtaining parameter P̅. The parameter P̅ represents the overall average brightness of the processed image of the formatted image data. The obtaining process involves summing the brightness values of each pixel and recording it as ΣP_{i,j}, and then dividing the sum by the total number m×n of pixels in the processed image. When the total number of pixels in the image is 1920×1080, the total number of pixels is approximately 2,073,600. If the total brightness sum is 2.50×10⁸, the average brightness can be calculated according the following formula

$$\overline{P} = \frac{2.5 \times 1 {0}^{8}}{2073600} \approx 120 .$$

Obtaining m and n. In this embodiment, m refer to the number of rows in the processed image of the formatted image data, and n refers to columns in the processed image of the formatted image data, both m and n are the pixel resolution information of the processed image itself. If the image resolution is 1920×1080, then m=1920, and n=1080. The m and n can be read from the image file header or metadata, for example, by reading the width of the image as 1920 pixels and the height as 1080 pixels, thus obtaining the m and n.

Obtaining parameters P_{i-1,j} and P_{i,j-1}. These two parameters represent the brightness of the adjacent upper pixel in the vertical direction and the adjacent left pixel in the horizontal direction for the current pixel. That is, P_{i-1,j} and P_{i,j-1} represent brightness values of a top pixel and a left pixel adjacent to a current pixel. During pixel traversal process, row and column data are read once. For example, for a pixel at coordinate (i, j), the brightness values at (i−1, j) and (i, j−1) can be read and stored in cache before accessing the current pixel or dynamically read during the calculation. For example, when scanning the 3rd row and 10th column, the brightness values at the 2nd row and 10th column, and the 3rd row and 9th column, can be retrieved from memory. If the upper pixel brightness is 140 and the left pixel brightness is 138, P_{i-1,j}=140, P_{i,j-1}=138 are recorded.

Calculation Process is as follows.

Setting the image size be 1080 rows×1920 columns, i.e., m=1080, n=1920.

Obtaining values of Pₘₐₓ=247, Pₘᵢₙ=12, and P̅=120.

Scanning the pixel brightness P_{i,j} of the entire processed image and add up the brightness of each pixel in the formula as follows:

$${\sum }_{i = 1}^{1080} {\sum }_{j = 1}^{1920} ( \frac{\vert {P}_{i , j} - 12 \vert}{247 - 12} + \frac{\vert {P}_{i , j} - 120 \vert}{120} + \frac{\vert {P}_{i , j} - {P}_{i - 1 , j} \vert + \vert {P}_{i , j} - {P}_{i , j - 1} \vert}{2} ) .$$

Summing the three difference terms for each pixel separately, then add to the total sum.

Recording the total sum from the previous step be SumAll; and then divide by the total number of pixels, that is 1080×1920=2073600.

Finally, computing a square root to obtain the contrast score

$$C = \sqrt{\frac{1}{2073600} \times SumAll} .$$

For example, if the total sum after scanning and statistics is approximately 3.32×10⁸, thus obtaining

$$C = \sqrt{\frac{332 \times {10}^{8}}{2073600}} \approx \sqrt{160} \approx 12.65 .$$

The result indicates that the overall contrast score of the image is 12.65. A higher score means a greater brightness difference, and different images of the formatted image data may have contrast scores in the range of 6 to 20. By comparing the values of different images, we can identify which image has higher or lower contrast, which can provide a reference for subsequent grayscale mapping or other equalization operations.

Based on the contrast score and combined with the image's minimum, maximum, and average brightness values, specific regions can be analyzed by reading the previously obtained brightness distribution data row by row. For example, if the brightness distribution records show that a significant proportion of pixels are concentrated between brightness values of 80 to 180, and this proportion exceeds 40%, this range is considered a medium brightness area. Similarly, for the low brightness region (0 to 80), if the proportion exceeds 30%, this area will be prioritized for grayscale mapping enhancement. For the high brightness region (180 to 255), if the proportion exceeds 20%, this area will be compressed or redistributed using a correction curve.

The process will map pixel brightness to an adjustable curve and record it in real-time memory. The curve shape can be defined in segments based on the gain coefficient and threshold values. For example, when the brightness is below 80, the segment gain coefficient is set between 1.2 and 1.4 to enhance the dark regions. When the brightness is between 180 and 255, the gain coefficient is set between 0.8 and 1.0 to balance the overly bright areas. The transition points in the curve may have an attenuation value (e.g., between 0.05 and 0.1) to prevent significant brightness jumps at the boundaries.

These specific threshold and gain values are determined from previous image processing experiences, such as by analyzing the histogram distribution of 20 images with significant dark and bright regions and defining the boundaries between dark and bright areas. After multiple tests, the attenuation values between 0.05 and 0.15 are considered appropriate, and the gain between 1.2 and 1.5 is suitable for significant brightness enhancement in the dark areas.

Both the dark and bright areas undergo segment-based processing rather than applying uniform gain to the entire image to avoid excessive enhancement or reduction of local details. After the processing, the pixel brightness distribution after segmentation mapping is summarized, and a new brightness table is formed. Then, the updated grayscale values are generated row by row, ultimately resulting in the optimized image data.

As shown in FIG. 6, S2 of based on the optimized image data, performing a target detection to identify other vehicles and road signs, and getting target detection results is as follows.

S21, inputting the optimized image data into a deep learning model for target region feature extraction, through a convolutional neural network to perform layer-by-layer convolution operations on image blocks of candidate regions, and pooling operations are combined to reduce redundant information, and a class probability distribution of each candidate region is calculated and converted into a fixed-dimension vector via a fully connected layer to generate target recognition result data.

S22, based on the target recognition result data, filtering out target data with category confidence levels that meet a set threshold, taking the target data as the target detection results.

Specifically, inputting the optimized image data into a deep learning model for target region feature extraction. Firstly, the existing training samples will be annotated, and the boundary box coordinates and class information of the target regions in each of samples (optimized image data) will be recorded. These labeled samples will then be divided into training and validation sets, ensuring that the training set includes no fewer than 10,000 images and covers various scenes and target categories. After combining the optimized image data from each image in the training set with its corresponding label, the data will be input into a convolutional neural network (CNN), with the learning rate set to 0.001, the batch size to 32, and the number of training epochs to 50. During layer-by-layer convolution operation, the optimized image data will first be read at the network's input and processed by a convolutional kernel with a specified size to perform calculations on image blocks. In the convolution process, the weights of each channel will be recorded and updated with mean shift parameters. After each convolution, a pooling operation with a specified size will be applied, retaining only the maximum value in the local region to compress redundant data. During training, each iteration will calculate cross-entropy loss and perform backpropagation to update the parameters of the convolutional kernels and fully connected layers. The iteration will stop when the cross-entropy loss on the validation set converges to less than 0.02 for three consecutive epochs. Afterward, the network parameters will be fixed, and new optimized image data will be input. For each candidate region's image block, edge, texture, and higher-level feature information will be progressively extracted in the convolutional and pooling layers, and in the fully connected layer, the feature map will be converted into a fixed-dimensional vector. This will allow the calculation of the probability distribution of each region belonging to each target category. During this process, the number of output neurons will be adjusted based on the number of categories, and the total probability will be constrained to 1. When the probability value of a particular category is the highest among all outputs, it will be considered as the recognition result for that candidate region. The category distribution and probability score for each region will be recorded and integrated into the output structure, ultimately generating the target recognition result data.

Based on the target recognition result data, the category confidence values of each candidate region will be read and compared with the best confidence threshold obtained from approximately 2,000 images. This threshold was determined to be 0.75 based on experiments with precision and recall as evaluation metrics. The method is to select different confidence thresholds from 0.5 to 0.9, increasing by 0.05 each time, and test them while recording the detection accuracy and false negative rate for each threshold. After repeating the comparison for the same set of images, the threshold that optimally balances accuracy and false negative rate, 0.75, will be chosen. Then, when analyzing the current target recognition result data, if the category confidence exceeds 0.75, the candidate region will be marked as a valid target, and the target category name and confidence value will be appended during output. If the category confidence is below 0.75, the candidate region will be discarded from output. Regardless of the number of candidate regions, this process will be repeated for each one, and the targets that meet the requirements will be classified and integrated. The number of targets meeting the threshold will be recorded, along with their location coordinates, and the final target detection result data will be obtained.

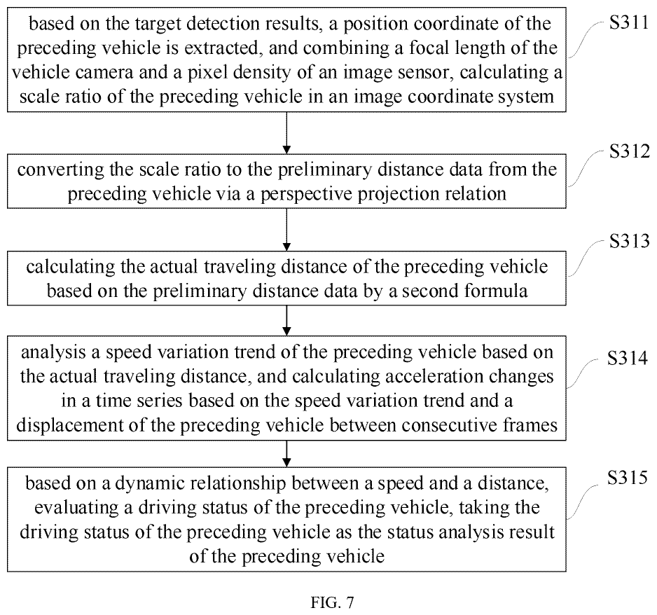

As shown in FIG. 7, S3 of the preceding vehicle includes preliminary distance data between the host vehicle and the preceding vehicle and an actual traveling distance of the preceding vehicle; the acquisition step of analyzing the target detection results to evaluate a distance data between the host vehicle and a preceding vehicle, calculating a status analysis result of the preceding vehicle based on the distance data from the preceding vehicle is as follows.

S311, based on the target detection results, a position coordinate of the preceding vehicle is extracted, and combining a focal length of the vehicle camera and a pixel density of an image sensor, calculating a scale ratio of the preceding vehicle in an image coordinate system.

S312, converting the scale ratio to the preliminary distance data from the preceding vehicle via a perspective projection relation.

S313, calculating the actual traveling distance of the preceding vehicle based on the preliminary distance data by a second formula, the second formula is as following:

$$D = \frac{F \times W}{2 \times {tan}^{- 1} ( \frac{C P}{2 \times S} )} ;$$

D is the actual traveling distance of the preceding vehicle, F is a focal length of the vehicle camera of the host vehicle, W is a width of the preceding vehicle, CP is a pixel width of a target detection box, and S is a single pixel size of the image sensor.

S314, analysis a speed variation trend of the preceding vehicle based on the actual traveling distance, and calculating acceleration changes in a time series based on the speed variation trend and a displacement of the preceding vehicle between consecutive frames.

S315, based on a dynamic relationship between a speed and a distance, evaluating a driving status of the preceding vehicle, taking the driving status of the preceding vehicle as the status analysis result of the preceding vehicle.

Specifically, based on the target detection results, the pixel coordinate range of the preceding vehicle will be read, and a group of reference pixels located at a center position will be selected as the basis for calculation. Firstly, the focal length parameter and the corresponding calibration file for the image sensor's pixel density will be confirmed at the camera installation site, and the focal length value and physical size corresponding to each unit of pixels will be recorded. Then, based on the identified position coordinates of the preceding vehicle, the rectangular region occupied by the vehicle will be extracted, and the pixel width and height of this region will be counted. By multiplying the pixel dimensions by the pixel density value recorded in the calibration file, preliminary scale information corresponding to the length can be obtained. To maintain consistency in environments with strong light or at night, multiple environmental data sets in the calibration file will be compared before each shot, and the contrast correction parameters that are closest to the current brightness range will be selected. Once usable contrast correction parameters are confirmed, they will be applied during the recognition phase of the camera's output image. The changes in the boundary of the preceding vehicle's position over several consecutive frames will be recorded. By comparing the differences in pixel width and height between adjacent frames, the scaling trend will be assessed, and this will be compared with the relative position of the camera's optical center. When both pixel width and height show an increasing trend and exceed the reference threshold specified in the calibration file, it will be determined that the distance between the preceding vehicle and the host vehicle is decreasing. The pixel increment and optical transformation relationship will be calculated in real-time. The reference threshold is determined by testing various vehicle sizes under fixed focal length conditions, and it typically falls between 5 to 20 pixel increments. If the increment exceeds 10 pixels, it will be considered a significant change, and a perspective projection conversion will be performed immediately. The pixel increment will be associated with the camera's principal point and the imaging plane distance to derive the relative distance change between the preceding vehicle and host vehicle. Then, by combining the camera's focal length and other parameters, the size proportion of the preceding vehicle in the image plane will be calculated and matched with the previously registered projection matrix entry. This matrix table was calibrated during the installation phase of the vehicle detection system using a fixed-point target. For each pixel ratio, there is a unique corresponding distance information. Finally, the results of multiple frame comparisons will be merged to generate a relatively stable average distance, which will be used as the preliminary distance data of the preceding vehicle.

The benefit of the second formula is that by incorporating multi-dimensional factors such as pixel width, focal length, actual vehicle width, and sensor pixel size, the pixel measurements in the image can be accurately mapped to the real-world distance dimensions in a simpler form, thus providing higher accuracy for vehicle distance calculation. The following are the steps to obtain each parameter.

Obtaining the parameter F. The parameter F represents the focal length the vehicle camera of the host vehicle, which is usually calibrated by the lens manufacturer before shipping or can be measured using a high-precision calibration procedure. During calibration, a target will be placed at a fixed distance, and the camera will be aligned with the target. The distance between the camera lens center and the imaging plane when a clear image is captured will be recorded, quantified in millimeters. For example, the focal length obtained through actual calibration is 6 mm, that is F=6 mm.

Obtaining the parameter W. The parameter W refers to the width of the preceding vehicle.

Obtaining the parameter CP. The parameter CP represents the pixel width of the preceding vehicle's detection box in the image, which needs to be obtained through target detection results. Specifically, the left and right edge coordinates of the preceding vehicle in the image plane will be read and the difference between them will be calculated, stored in pixels. If the left edge is at pixel x₁ and the right edge is at pixel x₂ in the image coordinate system, the difference in pixel values is CP=x₂−x₁. When conducting inspections, the vehicle recognition algorithm will be used to mark the contour area of the vehicle accurately to the pixel coordinates, and then the difference in these coordinates will be counted as CP. For example, in a 1920×1080 image, if the left edge of the preceding vehicle detection box is at 420 pixels and the right edge is at 720 pixels, the difference would be 300 pixels, that is CP=300.

Obtaining the parameter S. The parameter S is the single pixel size of the image sensor, which must be referenced or calibrated according to the specific camera model. During calibration, a traceable micrometer tool can be used to measure the total size of the sensor in micrometers, and the single-pixel size can be calculated by dividing the sensor size by the number of effective pixels. For example, if the horizontal sensor size is 3.456 mm and the number of effective pixels is 1920, the pixel size would be calculated:

$$S = \frac{3.456 mm}{1920} \approx 0.0 \; 018 mm .$$

Calculation Process is as follow.

Firstly, listing all parameters: F=6 mm, W=1800 mm, CP=300, and S=0.006 mm.

Secondly, substituting the above values into the second formula, to obtain:

$$D = \frac{6 \times 1800}{2 \times {tan}^{- 1} ( \frac{300}{2 \times 0.006} )} .$$

Thirdly, calculating the value inside the denominator

$$\frac{C P}{2 \times S} ,$$

to obtain:

$$\frac{300}{2 \times 0.006} = \frac{300}{0.012} = 25000 .$$

Fourthly, calculating tan⁻¹(25000).

Using a table or calculation, to obtain tan⁻¹(25000)≈1.5707, which is approximately 89.97 degrees.

Fifthly: organizing the denominator and complete the calculation, to obtain:

$$2 \times 1.5707 = 3.1 \; 414 ; 6 \times 1800 = 10 \; 800 ; D = \frac{10800}{3.1414} \approx 3437.07 .$$

This result indicates that the actual driving distance D of the preceding vehicle in the current frame is 3437.07 mm, approximately 3.437 m. If, during subsequent detection, the CP increases with time, it indicates that the preceding vehicle is moving closer. If the CP continues to shrink, it indicates that the distance is increasing. Therefore, the second formula can reflect the change in vehicle spacing in real-time during multi-frame calculations.

Based on the actual driving distance of the preceding vehicle, the displacement of the preceding vehicle in the ground coordinate system will be recorded for consecutive image frames, with a fixed sampling interval of 0.04 seconds between each frame. When reading the distance difference between the preceding vehicle in the k-th frame and the k+1-th frame, if the distance difference is between 0.01 m and 0.3 m, it indicates that the preceding vehicle is in a small range of movement. If the distance difference exceeds 0.3 m, it is considered rapid displacement. This will be treated as a key displacement for acceleration analysis when calculating speed. By dividing the distance difference between adjacent frames by 0.04 seconds, the instantaneous speed of the preceding vehicle is calculated, and this value is used to compare again in adjacent frames. The unit of speed in this embodiment is meters per second (m/s). If the speed increment is between 0.1 m/s and 3 m/s, this value will be recorded and added to the acceleration sequence. If the speed increment is less than 0.1 m/s, it indicates that the speed is essentially constant and will not be included in the acceleration calculation. If the increment exceeds 3 m/s, it is considered a drastic change, and the next frame data will continue to be monitored. During this process, a speed threshold table, based on the results from the past 600 frames, is referenced to determine whether there are abnormal fluctuations. This speed threshold table is divided into low-speed intervals below 3 m/s, normal intervals between 5 m/s and 15 m/s, and high-speed intervals above 15 m/s, with further subdivisions for different vehicle types. Then, when analyzing the acceleration sequence, each acceleration value will first be compared with a reasonable range. For example, the acceleration will be compared within the range of 0 m/s² to 10 m/s². If the acceleration exceeds 10 m/s², it will be marked as an extreme acceleration value, and the subsequent speed changes of that video frame will continue to be monitored. Finally, all speed and acceleration results will be combined into a time series, and the average speed and median acceleration of each frame will be calculated to evaluate the driving state of the preceding vehicle during the following process. Combined with the distance change trend, possible situations such as congestion or unobstructed passage can be distinguished, and the status analysis result of the preceding vehicle will be generated.

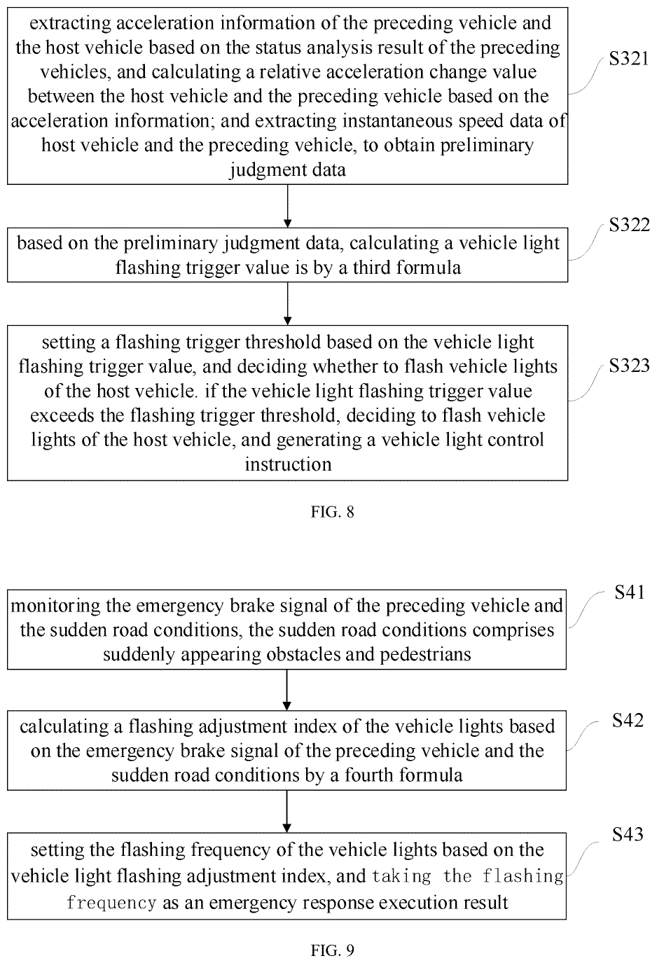

A shown in FIG. 8, S3 of based on the status analysis result of the preceding vehicle, deciding whether to flash vehicle lights, and generating a vehicle light control instruction is as follows.

S321, extracting acceleration information of the preceding vehicle and the host vehicle based on the status analysis result of the preceding vehicles, and calculating a relative acceleration change value between the host vehicle and the preceding vehicle based on the acceleration information; and extracting instantaneous speed data of host vehicle and the preceding vehicle, to obtain preliminary judgment data.

S322, based on the preliminary judgment data, calculating a vehicle light flashing trigger value is by a third formula, the first formula is as following:

$$Z F = \frac{\vert {A}_{1} - {A}_{2} \vert}{\sqrt{{( Z {S}_{1} - Z {S}_{2} )}^{2} + {L}^{2}}} \times ( 1 + \frac{\vert {V}_{1} - {V}_{2} \vert}{{V}_{1} + {V}_{2}} ) .$$

ZF is the vehicle light flashing trigger value, A₁ is a current acceleration of the preceding vehicle, A₂ is a current acceleration of the host vehicle, ZS₁ is an instantaneous speed of the preceding vehicle, ZS₂ is the instantaneous speed of the host vehicle, L is the relative distance between the preceding vehicle and the host vehicle, V₁ is a speed of the preceding vehicle at last moment, and V₂ is a speed of the host vehicle at the last moment.

S323, setting a flashing trigger threshold based on the vehicle light flashing trigger value, and deciding whether to flash vehicle lights of the host vehicle. if the vehicle light flashing trigger value exceeds the flashing trigger threshold, deciding to flash vehicle lights of the host vehicle, and generating a vehicle light control instruction.

Specifically, based on the status analysis result of the preceding vehicle, the first step is to read the acceleration information of the preceding vehicle and the host vehicle, which was recorded in the previous stage. Then, check whether the sources of the two sets of acceleration values are complete. The acceleration information of the preceding vehicle is calculated based on the displacement difference identified in consecutive video frames and the corresponding time series, with a time interval set to 0.04 s. The acceleration information of the host vehicle: obtained by accumulating the longitudinal acceleration data output by the onboard sensors within the same 0.04 s time step and then splitting it into specific time values for each segment. Next, the relative acceleration change between the preceding vehicle and the host vehicle is calculated by comparing the accelerations at the same timestamp. This change is recorded as a new data sequence. If the relative acceleration change exceeds the upper limit of 5 m/s², which was measured in road tests, it is marked as a rapid change interval and will be compared in more detail at the next timestamp. If the relative acceleration change is less than 0 m/s², it is marked as a deceleration interval, and the acceleration in the next frame of data will continue to be tracked. Then, instantaneous speed data of both the preceding vehicle and the host vehicle are extracted from the vehicle speed data set. The instantaneous speed of the preceding vehicle is calculated by dividing the distance increment between consecutive frames by 0.04 s and storing it in a speed sequence for each frame. The instantaneous speed of the host vehicle is taken from the onboard speed sensor, which records the data with a 0.04 s sampling period. The speed values from the preceding and host vehicle are then matched according to their positions in the respective instantaneous speed sequences, and the corresponding speed value from the previous moment is read and recorded. To ensure accurate speed matching, the timestamp difference is checked, and the error is kept within 0.01 s. If the speed difference between the preceding and host vehicle exceeds 5 m per second, it is recorded as a high-difference interval, and the status will be further confirmed in the subsequent cycles. If the speed difference remains high for three or more consecutive moments, a reminder message will be output to indicate a significant difference in the vehicle speeds. Once all these values are associated, they are integrated in chronological order to generate the preliminary data for the headlamp control determination.

The benefit of the third formula is that by introducing the acceleration difference, speed difference, and the distance between the preceding vehicle and host vehicle, it can measure the dynamic relationship between the two vehicles in a compact expression and provide a more comprehensive reference for headlamp flashing determination. The following outlines the steps for acquiring each parameter.

Acquiring the parameter A₁. The parameter A₁ represents the current acceleration of the preceding vehicle, with units optional in meters per second squared (m/s²). The acceleration is obtained by dividing the displacement change of the preceding vehicle between consecutive frames by the frame interval to get speed, and then performing a first-order difference on speed divided by the time step. For example, in urban road tests, it was found that the average acceleration of the preceding vehicle ranges from 0 m/s² to 5 m/s². After real-time calculations, an accurate instantaneous acceleration value is formed at each sampling moment. For instance, the value at a certain time could be recorded as 2.2 m/s², that is A₁=2.2 m/s².

Acquiring the parameter A₂. The parameter A₂ represents the current acceleration of the host vehicle, with units also in meters per second squared (m/s²). It is primarily obtained from the acceleration sensor of the host vehicle and output data of an electronic control unit (ECU). Specifically, the longitudinal acceleration sensor value at this moment is read. In urban expressway or highway scenarios, reference to whole-vehicle test results shows that the value mostly falls between 0 m/s² and 4 m/s². If the value exceeds this range, a recheck is performed to confirm whether there is a measurement deviation in the sensor. For example, if the host vehicle's measured acceleration is 1.5 m/s², that is A₂=1.5 m/s².

Acquiring the parameter ZS₁. The parameter ZS₁ represents the instantaneous speed of the preceding vehicle, with units in meters per second (m/s). The calculation is similar, and it is also derived from the change in distance between image frames and the time interval. On urban roads, the preceding vehicle's speed generally ranges from 0 m/s to 20 m/s. For example, if the instantaneous speed of the preceding vehicle is calculated to be 15.0 m/s at a certain moment, that is ZS₁=15.0 m/s.

Acquiring the parameter ZS₂. The parameter ZS₂ represents the instantaneous speed of the host vehicle, with units in m/s. It is obtained from the host vehicle's instrument panel, ECU, or speed sensor and recorded in the software. Based on benchmark tests, the host vehicle's speed on urban roads mainly ranges from 0 m/s to 25 m/s. Suppose the current speed value is read as 17.5 m/s; that is ZS₂=17.5 m/s.

Acquiring the parameter L. The parameter L represents the relative distance between the preceding vehicle and the host vehicle, with units optionally in meters (m). It is obtained by subtracting the reference distance from the host vehicle's front to the camera installation point from the previously obtained distance between the preceding vehicle and the host vehicle. If the distance data of the preceding vehicle has already been obtained in the previous stage using methods like camera-based distance measurement or millimeter-wave radar, the corresponding value can be taken directly at this moment. For urban driving scenarios, the relative distance can be judged to range from 2 meters to 100 meters. For example, if the calibrated distance between the centers of the preceding and host vehicle is 30.0 m, and the distance from the host vehicle's front to the camera is 1.0 m, then L=29.0 m.

Acquiring the parameter V₁. The parameter V₁ represents the previous moment's speed of the preceding vehicle, with units also in m/s. The historical speed sequence of the preceding vehicle is referenced, and the value at the time index of the previous moment is taken as this parameter. In offline or online processing, the speed value from the previous frame or previous sampling period can be quickly retrieved. For example, if the current speed of the preceding vehicle is 15.0 m/s, and the speed recorded at the previous moment was 14.0 m/s, that is V₁=14.0 m/s.

Acquiring the parameter V₂. The parameter V₂ represents the previous moment's speed of the host vehicle, with units in m/s. It is obtained by referencing the host vehicle's speed sequence at the previous index. In urban driving scenarios, the host vehicle's speed often fluctuates over short periods, so a high-frequency record is maintained in the time series. If the speed at the previous moment is 17.0 m/s, that is V₂=17.0 m/s.

The calculation process is as follows.

Firstly, selecting parameters at a specific moment:
A₁=2.2, A₂=1.5, ZS₁=15.0, ZS₂=17.5, L=29.0, V₁=14.0, and V₂=17.0.

Secondly, calculating a numerator |A₁-A₂|, to obtain |2.2-1.5|=0.7.

Thirdly, calculating a denominator \sqrt{(ZS₁−ZS₂)²+L²}, to obtain:
(S₁-S₂)²=(15.0-17.5)²=(−2.5)²=6.25; and
6.25+29.0²=6.25+841.0=847.25; and
\sqrt{847.25}≈29.11.

Fourthly, calculating a velocity ratio part in the parentheses

$$( 1 + \frac{\vert {V}_{1} - {V}_{2} \vert}{{V}_{1} + {V}_{2}} ) ,$$

to obtain:
   |14.0-17.0|=3.0; and
14.0+17.0=31.0; and

$$\frac{3.}{31.} \approx 0.0968 ; and$$

$$1 + 0. 0968 = 1.0968 .$$

Fifthly, combining the results above, to obtain:

$$ZF = \frac{0.7}{29.11} \times 1.0968 ; and$$

$$\frac{0.7}{29.11} \approx 0.0 \; 2406 ; and$$

$$0.02 406 \times 1.0968 \approx 0.0264 .$$

This result indicates that at this specific moment ZF≈0.0264, if subsequent steps to determine whether to flash vehicle lights, this value will be compared with the vehicle light flash trigger threshold. If it exceeds the threshold, the vehicle lights will start flashing; if it is below the threshold, the current state of the vehicle lights will be maintained.

Based on the vehicle light flashing trigger value, the value at the current moment will be selected from the previously obtained trigger value sequence and compared with the vehicle light flash trigger threshold. The threshold setting method is based on car-following data from more than 300 hours of driving, selecting boundary points from the driving speed and relative acceleration curve to determine the critical range. For example, when the distance between the current car and the preceding car is within the 5 m to 30 m range, the speed and acceleration differences are continuously monitored, and the distribution of trigger values is recorded. Finally, a range of 0.2 to 0.3 is selected as the feasible threshold range, and after testing in multiple operating conditions, 0.25 is set as the trigger threshold for the vehicle light flashing. If the vehicle light flashing trigger value calculated at the current moment exceeds 0.25, it is determined that the flashing condition is met, and the light output switching frequency is set in the vehicle light control program, for example, flashing within the range of 0.8 to 1.2 seconds. If it does not exceed 0.25, the current vehicle light state is maintained. The current moment's trigger value is then recorded along with the time index in the trigger value sequence. The sequence will also be monitored and extended. If the trigger values of five consecutive sampling moments exceed the threshold, the flashing time will be extended or the flashing frequency will be increased. If it only exceeds the threshold for a short time, the flashing will stop after the vehicle's speed or acceleration falls back. All flashing actions must be compared with the brake signal status in the vehicle's electronic system to complete the final output action. Finally, the vehicle light control program will issue a vehicle light control instruction.

As shown in FIG. 9, S4 of monitoring an emergency brake signal of the preceding vehicle and sudden road conditions, and updating a flashing frequency of the vehicle lights based on the emergency brake signal of the preceding vehicle and the sudden road conditions, taking the flashing frequency as an emergency response execution result is as follows:
S41, monitoring the emergency brake signal of the preceding vehicle and the sudden road conditions, the sudden road conditions includes suddenly appearing obstacles and pedestrians; and
S42, calculating a flashing adjustment index of the vehicle lights based on the emergency brake signal of the preceding vehicle and the sudden road conditions by a fourth formula, the fourth formula is as following:

$$I = \frac{{e}^{( - d / R )}}{1 + {e}^{( - Δ s / T )}} ;$$

I is the flashing adjustment index, d is an actual distance between the host vehicle to the preceding vehicle or the sudden road conditions, R is a safety distance threshold, Δs is a speed difference, and T is a reaction time constant.

S43, setting the flashing frequency of the vehicle lights based on the vehicle light flashing adjustment index, and taking the flashing frequency as an emergency response execution result.

Specifically, the emergency brake signal of the preceding vehicle and sudden road conditions are monitored by synchronizing the vehicle camera of the host vehicle and the onboard brake monitoring device to read real-time information. The vehicle's speed, deceleration, and road surface image data at that moment are recorded. The continuous monitoring time interval is set to 0.05 s, and during this interval, the brake light status and acceleration values of the preceding vehicle are repeatedly compared. If the brake light is high and the corresponding acceleration drops below −4 m/s², it is recorded as emergency deceleration. If new obstacles or pedestrians are detected on the screen and their coordinates have moved significantly between the original frame and the current frame, this situation is marked as an emergency change. When brake or obstacle detection is marked in three consecutive samplings, it confirms an emergency event, and multiple data of the emergency event are written into the emergency situation data sequence. The sequence includes the preceding vehicle's brake mark, obstacle pixel coordinates, and detected pedestrian speed. If multiple pedestrians are detected crossing the road within the monitoring period, their movement distance between 10 m and 30 m is calculated, and the number of frames they appear in the camera footage is multiplied by 0.05 seconds per frame as the duration of walking. After identifying emergency situations exceeding each threshold on the lane, subsequent displacement changes and vehicle acceleration will be tracked and updated in the data sequence. If the emergency situation only occurs within one sampling cycle, it will be verified in subsequent cycles whether it has been resolved. All markings will be included in the emergency situation data for continued use and recorded by time period, allowing later processing stages to precisely locate when the emergency brake or obstacle appearance occurred, ultimately obtaining the emergency situation data.

The benefit of the fourth formula is that by combining the actual distance between the vehicle and the obstacle or preceding vehicle with the speed difference, and quantitatively representing the exponential decay and exponential growth characteristics, multiple risk factors are comprehensively reflected in a single expression. The steps for obtaining each parameter are explained below.

Obtaining the parameter d. The parameter d represents the actual distance between the host vehicle to the preceding vehicle or the sudden road conditions and can be obtained via vehicle distance radar or image-based perspective measurement methods, with units in meters (m). The measured distance is updated every 0.05 s or 0.1 s. To ensure accuracy, the camera focal length and a reference list of known obstacle sizes can be used for calibration. When the measured distance between vehicles is between 2 m and 100 m, it is considered normal car-following or general obstacle distance range. If it is below 2 m, it is marked as an extreme proximity situation and annotated in the distance record. For example, after measurement, the distance to the obstacle at this moment is recorded as meters and will be used in subsequent calculations.

Obtaining the parameter R. The parameter R is the safety distance threshold, in meters, determined by referring to road driving norms and vehicle brake test data before the vehicle is on the road. Typically, in urban environments, it can be set between 10 m and 30 m. If the vehicle speed is higher or the road environment is special, higher values are used, such as 25 m or 30 m. The specific method involves simulating multiple vehicles in dry road conditions performing emergency braking tests at different speeds, measuring braking distances, and selecting an appropriate threshold according to legal requirements for safe car-following distance. In this embodiment, R=30 m.

Obtaining the parameter Δs. The parameter Δs represents the speed difference, usually determined by the speed difference between the preceding vehicle and the host vehicle, or the relative motion speed difference between the vehicle and the obstacles, with units in m/s. The speed readings at the moment are compared to calculate it. For example, if the preceding vehicle is traveling at 50 km/h and the host vehicle is at 40 km/h, the difference is 10 km/h, which is converted to

$$10 \times \frac{1000}{3600} \approx 2.78 m / s$$

and recorded as Δs=2.78 m/s.

Obtaining the parameter T. The parameter T is the response time constant, in seconds, used to represent the vehicle's response delay to an emergency situation. It can be calculated by measuring the average time from when the driver notices an obstacle to when effective deceleration is applied during multiple road tests, or by measuring the delay from when the onboard control system detects vehicle posture changes to when the braking signal is executed. Referring to about 500 evaluations in urban driving environments, the most common human-machine reaction time falls within the 0.8 s to 1.2 s range, so a value of T=1.0 can be selected for practical use.

Calculation Process is as follows.

Firstly, listing all parameters: d=10, R=30, Δs=2.78, T=1.0.

Secondly, calculating e^{(-d/R)}, to obtain:

$$\frac{d}{R} = \frac{10}{30} = \frac{1}{3} \approx 0.3333 ; and$$

$${e}^{- 0.3333} \approx 0.71653 .$$

Thirdly, calculating the denominator 1+e^{(-Δs/T)}, to obtain:

$$\frac{Δ s}{T} = \frac{2.78}{1.0} = 2.78 ; and$$

$${e}^{- 2.78} \approx 0.0613 ; and$$

$$1 + 0. 0613 = 1.0613 .$$

Fourthly, substituting into the fourth formula, to obtain:

$$I = \frac{0.71653}{1.0613} \approx 0.676 .$$

The result shows that when the current distance is 10 m and the speed difference is approximately 2.78 m/s, the flashing adjustment index is 0.676. A higher value indicates that the vehicle lights can flash at a moderate frequency under the current situation. If the value continues to rise to 0.9 or above, it can be concluded that the proximity to the vehicle or obstacle and the relative speed difference have further intensified, requiring a higher frequency of light signals to alert.

Based on the flashing adjustment index of the vehicle lights, the calculated flashing adjustment index value is first compared with the flashing frequency distribution ranges obtained from three sets of research data. The research data is based on 300 hours of urban road and 200 hours of highway driving tests, where the flashing frequency is categorized based on speed differences and distances, ranging from 1 flash per second to 4 flashes per second with a step size of 0.5 flashes per second. When the flashing adjustment index is between 0.6 and 0.7, it corresponds to a flashing range of 2 to 2.5 flashes per second. If the index rises to between 0.8 and 0.9, it corresponds to 3 to 3.5 flashes per second. If the index exceeds 0.9, it corresponds to 4 flashes per second. Subsequently, during vehicle operation, the instantaneous index changes are recorded and continuously compared. If the flashing adjustment index remains between 0.8 and 0.9 at multiple consecutive sampling points, the flashing frequency is fixed at 3 flashes per second. Later moments will assess whether it continues to increase. If the index drops below 0.2, it is determined to be a low-risk situation, and flashing is terminated or the tail light is turned on continuously. Throughout this process, the frequency settings for each sampling time will be adjusted in real-time to ensure that the final results can override previous settings. If the index suddenly drops or re-enters another range, the flashing frequency will be updated to the corresponding lower limit of that range, and the actual frequency selected at each moment will be recorded. After a certain period, the system will consolidate these frequency adjustments and output the final lighting control behavior as an emergency response execution result.

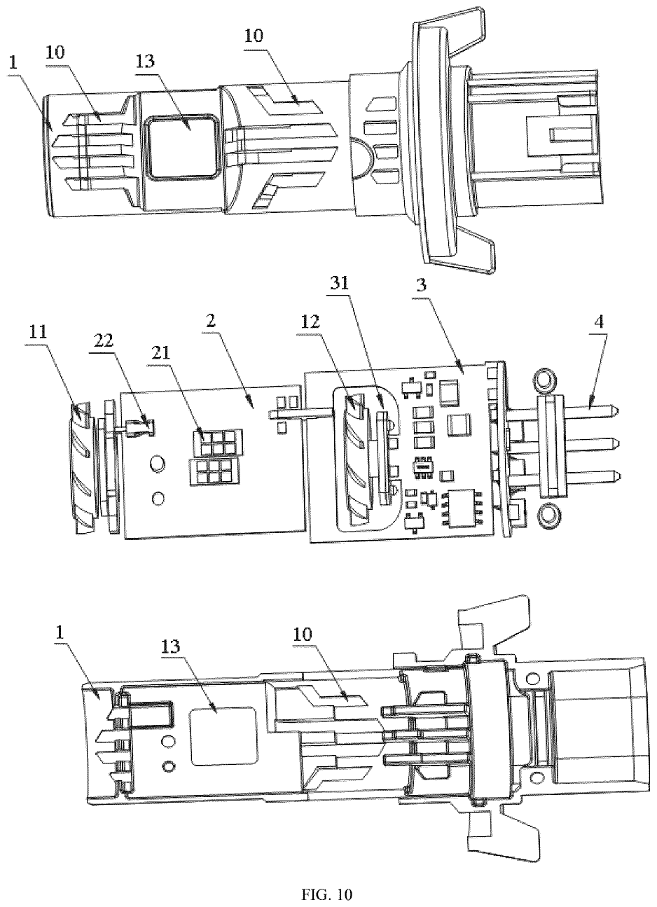

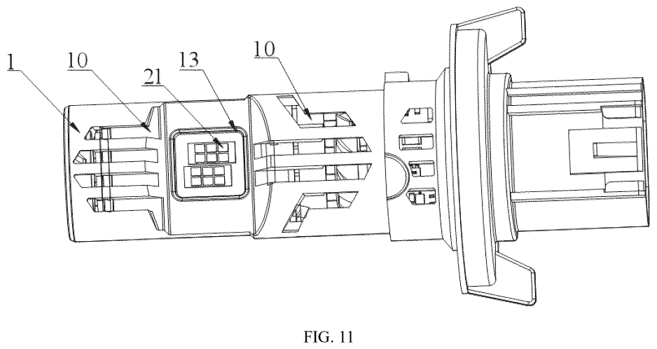

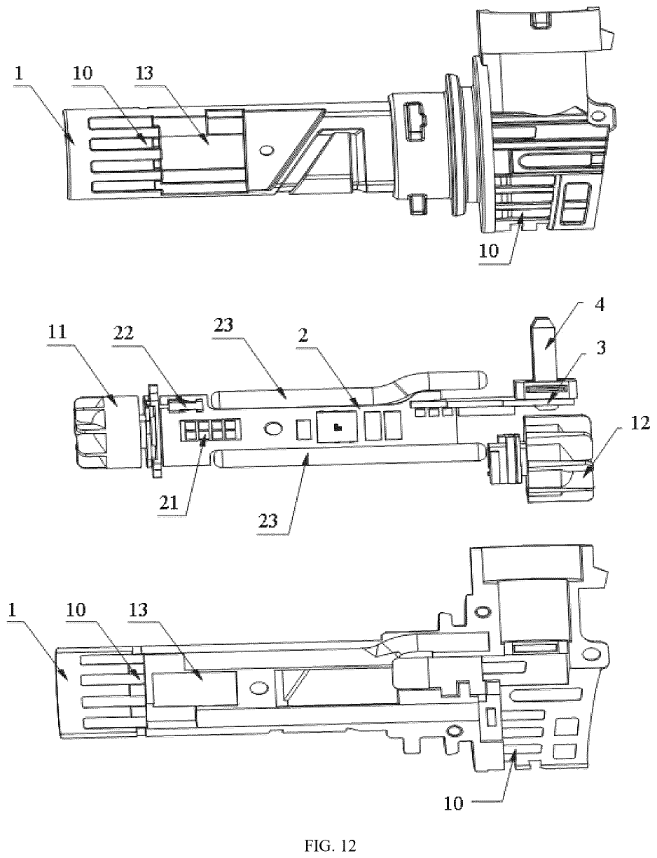

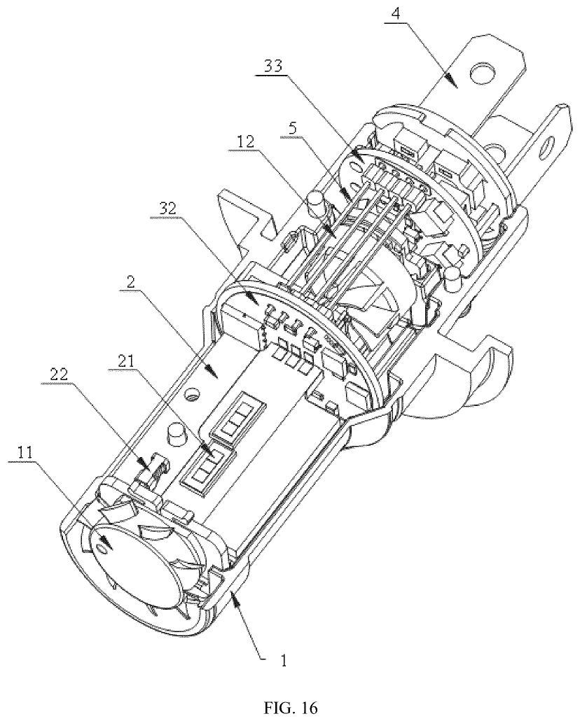

Please refer to FIGS. 10-16, The present disclosure also provides an onboard lighting device, being applied for the intelligent lighting control method mentioned in in the above embodiments. The onboard lighting device including: a lamp housing 1 with heat dissipation holes 10 on a outer wall, inside the lamp housing 1 there is a light source substrate 2 and a printed circuit board (PCB) 3 electrically connected to the light source substrate 2, with light emitting diode (LED) chips 21 mounted on both sides of the light source substrate 2. The lamp housing 1 also includes a first cooling fan 11 for dissipating heat from the light source substrate 2 and a second cooling fan 12 for dissipating heat from the PCB 3. The end of the lamp housing 1 is equipped with a plug 4 electrically connected to the rectifier on the PCB 3. The plug 4 can be configured with either a three-pin or two-pin setup depending on actual requirements, with no limitation in this embodiment. The light source substrate 2 is equipped with a connection terminal 22 electrically connected to the first cooling fan 11. The lamp housing 1 also has a light-transmitting opening 13 corresponding to a light-emitting surface of each of the LED chips 21, through which the light source substrate 2 illuminates the outside world.

It is important to note that the lamp housing 1 also provided with grooves for placing the first cooling fan 11 and the second cooling fan 12. During installation, the first cooling fan 11 is electrically connected to the light source substrate 2, then the light source substrate 2 and the second cooling fan 12 are electrically connected to the PCB 3, enabling power supply to supply to both cooling fans.

Regarding the first cooling fan 11, its intake or exhaust surface may face the LED chips 21 on the light source substrate 2, so that the heat generated by the LED chips 21 when powered on can be dissipated by the second cooling fan 11. During heat dissipation, the rotation direction of the first cooling fan 11 and the second cooling fan 12 can be synchronized to ensure that the hot air flows in the same direction and is directed through the light-transmitting opening 13, achieving a deflection effect.

In the first embodiment (FIGS. 10-11), the lamp housing 1 has a linear structure, and the PCB 3 has an installation opening 31 for the second cooling fan 12. When the PCB 3 is placed horizontally, the installation opening 31 penetrates the top and bottom sides of the PCB 3. The second cooling fan 12 is connected to the inner side wall of the installation opening 31, and its intake or exhaust surface faces the circuit wiring and electronic components on the PCB 3, ensuring the heat generated by the PCB 3 when powered on can be dissipated by the second cooling fan 12.

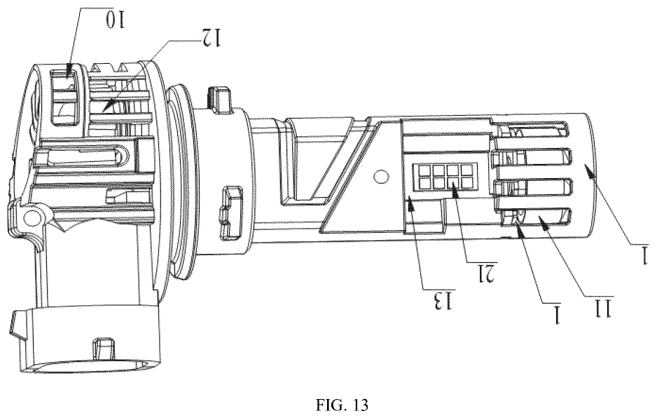

In the second embodiment (FIGS. 12-13), the lamp housing 1 has an L-shaped structure, and heat-conducting tubes 23 are provided on both sides of the light source substrate 2 for improved heat dissipation. The second cooling fan 12 is placed between the light source substrate 2 and the PCB 3. The light source substrate 2 is set horizontally within the lamp housing 1, and the PCB 3 is rotated 90 degrees and inserted at the end of the light source substrate 2 to make space for the second cooling fan 12 and facilitate the connection of the plug 4.

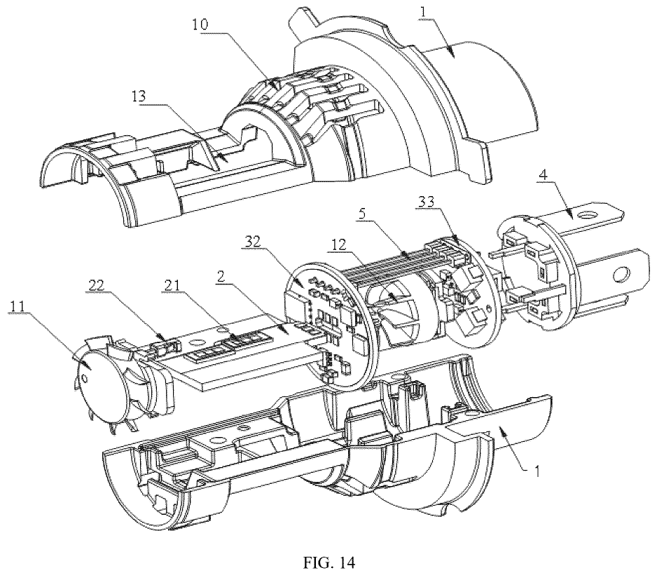

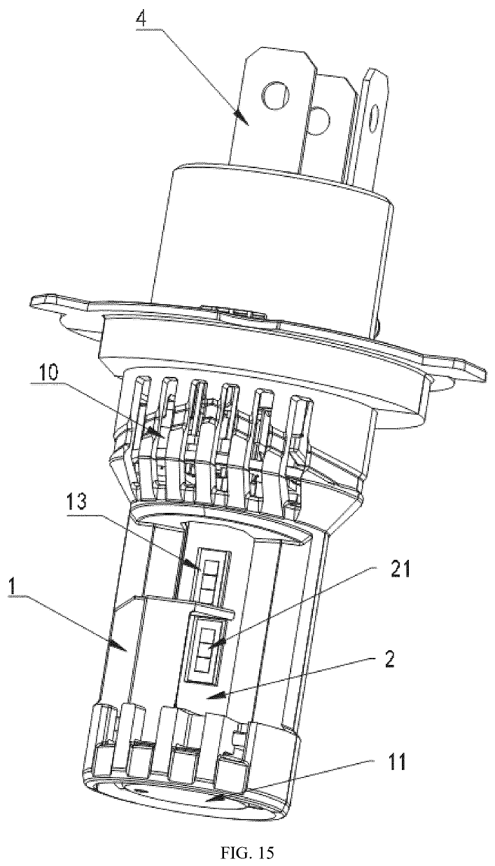

In the third embodiment (FIGS. 14-16), the PCB 3 includes a control circuit board 32 electrically connected to the light source substrate 2 and a rectifier circuit board 33 electrically connected to the plug 4. The second cooling fan 12 is positioned between the control circuit board 32 and the rectifier circuit board 33. The rectifier circuit board 33 is connected to the control circuit board 32 via a pin header 5, and a terminal of the second cooling fan 12 is connected to the rectifier circuit board 33. The control circuit board 32 has thermal air holes and mounting slots for the heat air to flow through, and the mounting slot is adapted to the end of the light source substrate 2.

The above are only some embodiments of the present disclosure, not intended to limit the disclosure in any other way. Any skilled technician can modify or alter the disclosed technical content into equivalent embodiments applicable in other fields. However, any simple modification, equivalent change, or alteration made without departing from the technical solution of the present disclosure will still fall within the protection scope of the disclosure.

What is claimed is:

1. An intelligent lighting control method, comprising the following steps:
S1, performing a format processing to continuous image data captured by a vehicle camera of a host vehicle to generate formatted image data; and optimizing the formatted image data by adjusting contrast to generate optimized image data; and
S2, based on the optimized image data, performing a target detection to identify other vehicles and road signs, and getting target detection results; analyzing the target detection results to evaluate a distance data between the host vehicle and a preceding vehicle, calculating a status analysis result of the preceding vehicle based on the distance data; and
S3, based on the status analysis result of the preceding vehicle, deciding whether to flash vehicle lights of the host vehicle, and generating a vehicle light control instruction; and
S4, monitoring an emergency brake signal of the preceding vehicle and sudden road conditions, and updating a flashing frequency of the vehicle lights based on the emergency brake signal of the preceding vehicle and the sudden road conditions, taking the flashing frequency as an emergency response execution result.

2. The intelligent lighting control method according to claim 1, wherein S1 of performing a format processing to continuous image data captured by a vehicle camera of the host vehicle to generate formatted image data is as follows:
S111, obtaining the continuous image data, the continuous image data is unprocessed raw image data, the raw image data is captured by the vehicle camera of the host vehicle, by adjusting parameters of a sensitivity and an aperture size of the vehicle camera based on the lighting conditions in the car to obtain the unprocessed raw image data;
S112, converting the continuous image data from a red, green and blue (RGB) color mode to a luminance and chrominance (YUV) color mode to obtain initial formatted image data;
S113, performing a high-pass filter process and an edge enhancement processing to the initial formatted image data, to obtain the formatted image data.

3. The intelligent lighting control method according to claim 1, wherein S1 of optimizing the formatted image data by adjusting contrast to generate optimized image data is as follows:
S121, calculating contrast score of the formatted image data by a first formula, the first formula is as following:
$$C = \sqrt{\begin{matrix}\frac{1}{m \times n} {\sum }_{i = 1}^{m} {\sum }_{j = 1}^{n} ( \frac{\vert {P}_{i , j} - {P}_{min} \vert}{{P}_{max} - {P}_{min}} + \frac{\vert {P}_{i , j} - \overline{P} \vert}{\overline{P}} + \\ \frac{\vert {P}_{i , j} - {P}_{i - 1 , j} \vert + \vert {P}_{i , j} - {P}_{i , j - 1} \vert}{2} )\end{matrix}} ;$$
wherein, C is the contrast score, P_{i,j} is a brightness value of a pixel at row i, column j; Pₘₐₓ and Pₘᵢₙ are maximum and minimum brightness values of the formatted image data; P̅ is an average brightness of the formatted image data; m and n are numbers of rows and columns; and P_{i-1,j} and P_{i,j-1} represent brightness values of a top pixel and a left pixel adjacent to a current pixel; and
S122, adjusting a grayscale mapping curve of the formatted image data based on the contrast score to uniformize a distribution of brightness values, resulting in the optimized image data.

4. The intelligent lighting control method according to claim 1, wherein S2 of based on the optimized image data, performing a target detection to identify other vehicles and road signs, and getting target detection results is as follows:
S21, inputting the optimized image data into a deep learning model for target region feature extraction, through a convolutional neural network to perform layer-by-layer convolution operations on image blocks of candidate regions, and pooling operations are combined to reduce redundant information, and a class probability distribution of each candidate region is calculated and converted into a fixed-dimension vector via a fully connected layer to generate target recognition result data;
S22, based on the target recognition result data, filtering out target data with category confidence levels that meet a set threshold, taking the target data as the target detection results.

5. The intelligent lighting control method according to claim 1, wherein S3 of the preceding vehicle comprises preliminary distance data between the host vehicle and the preceding vehicle and an actual traveling distance of the preceding vehicle; the acquisition step of analyzing the target detection results to evaluate a distance data between the host vehicle and a preceding vehicle, calculating a status analysis result of the preceding vehicle based on the distance data from the preceding vehicle is as follows:
S311, based on the target detection results, a position coordinate of the preceding vehicle is extracted, and combining a focal length of the vehicle camera and a pixel density of an image sensor, calculating a scale ratio of the preceding vehicle in an image coordinate system;
S312, converting the scale ratio to the preliminary distance data from the preceding vehicle via a perspective projection relation;
S313, calculating the actual traveling distance of the preceding vehicle based on the preliminary distance data by a second formula, the second formula is as following:
$$D = \frac{F \times W}{2 \times {tan}^{- 1} ( \frac{C P}{2 \times S} )} ;$$
wherein, D is the actual traveling distance of the preceding vehicle, F is a focal length of the vehicle camera of the host vehicle, W is a width of the preceding vehicle, CP is a pixel width of a target detection box, and S is a single pixel size of the image sensor;
S314, analysis a speed variation trend of the preceding vehicle based on the actual traveling distance, and calculating acceleration changes in a time series based on the speed variation trend and a displacement of the preceding vehicle between consecutive frames;
S315, based on a dynamic relationship between a speed and a distance, evaluating a driving status of the preceding vehicle, taking the driving status of the preceding vehicle as the status analysis result of the preceding vehicle.

6. The intelligent lighting control method according to claim 1, wherein S3 of based on the status analysis result of the preceding vehicle, deciding whether to flash vehicle lights, and generating a vehicle light control instruction is as follows:
S321, extracting acceleration information of the preceding vehicle and the host vehicle based on the status analysis result of the preceding vehicles, and calculating a relative acceleration change value between the host vehicle and the preceding vehicle based on the acceleration information; and extracting instantaneous speed data of host vehicle and the preceding vehicle, to obtain preliminary judgment data;
S322, based on the preliminary judgment data, calculating a vehicle light flashing trigger value is by a third formula, the first formula is as following:
$$Z F = \frac{\vert {A}_{1} - {A}_{2} \vert}{\sqrt{{( Z {S}_{1} - Z {S}_{2} )}^{2} + {L}^{2}}} \times ( 1 + \frac{\vert {V}_{1} - {V}_{2} \vert}{{V}_{1} + {V}_{2}} ) ;$$
wherein, ZF is the vehicle light flashing trigger value, A₁ is a current acceleration of the preceding vehicle, A₂ is a current acceleration of the host vehicle, ZS₁ is an instantaneous speed of the preceding vehicle, ZS₂ is the instantaneous speed of the host vehicle, L is the relative distance between the preceding vehicle and the host vehicle, V₁ is a speed of the preceding vehicle at last moment, and V₂ is a speed of the host vehicle at the last moment;
S323, setting a flashing trigger threshold based on the vehicle light flashing trigger value, and deciding whether to flash vehicle lights of the host vehicle, if the vehicle light flashing trigger value exceeds the flashing trigger threshold, deciding to flash vehicle lights of the host vehicle, and generating a vehicle light control instruction.

7. The intelligent lighting control method according to claim 1, wherein S4 of monitoring an emergency brake signal of the preceding vehicle and sudden road conditions, and updating a flashing frequency of the vehicle lights based on the emergency brake signal of the preceding vehicle and the sudden road conditions, taking the flashing frequency as an emergency response execution result is as follows:
S41, monitoring the emergency brake signal of the preceding vehicle and the sudden road conditions, the sudden road conditions comprises suddenly appearing obstacles and pedestrians; and
S42, calculating a flashing adjustment index of the vehicle lights based on the emergency brake signal of the preceding vehicle and the sudden road conditions by a fourth formula, the fourth formula is as following:
$$I = \frac{{e}^{( - d / R )}}{1 + {e}^{( - Δ s / T )}} ;$$
wherein, I is the flashing adjustment index, d is an actual distance between the host vehicle to the preceding vehicle or the sudden road conditions, R is a safety distance threshold, Δs is a speed difference, and T is a reaction time constant;
S43, setting the flashing frequency of the vehicle lights based on the vehicle light flashing adjustment index, and taking the flashing frequency as an emergency response execution result.

8. An onboard lighting device, being applied for the intelligent lighting control method of claim 1, comprising:
a lamp housing with heat dissipation holes on an outer wall;
a light source substrate and a printed circuit board (PCB) are located inside the lamp housing, the PCB is electrically connected to the light source substrate;
wherein both sides of the light source substrate is equipped with light emitting diode (LED) chips;
the lamp housing comprises a first cooling fan for cooling the light source substrate and a second cooling fan for cooling the PCB; and
an end of the lamp housing is equipped with a plug electrically connected to a rectifier of the PCB;
the light source substrate is equipped with a connection terminal electrically connected to the first cooling fan; and
the 1 amp housing further comprises a light-transmitting opening corresponding to a light-emitting surface of each of the LED light chips.

9. The onboard lighting device according to claim 8, wherein the lamp housing has a linear structure, and the PCB is defined with a mounting hole for the second cooling fan to be installed;
or, the lamp housing has an L-shape structure, with heat-conducting tubes provided on both sides of the light source substrate, and the second cooling fan is installed between the light source substrate and the PCB.

10. The onboard lighting device according to claim 8, wherein the PCB comprises a control circuit board and a rectifier circuit board;
wherein the control circuit board is electrically connected to the light source substrate, and the rectifier circuit board is electrically connected to the plug, with the second cooling fan positioned between the control circuit board and the rectifier circuit board; and the rectifier circuit board is connected to the control circuit board via a pin header, and a terminal of the second cooling fan is connected to the rectifier circuit board.
